(19) United States
(12) Patent Application Publication
(10) Pub. No.: US 2026/0217067 A1
(43) Pub. Date: Jul. 30, 2026

(54) AUTOMATIC STEM ASSEMBLY STATION

(71) Applicant: INTERNATIONAL WHEEL & TIRE COMPANY, Farmington Hills, MI (US)

(72) Inventors: Richard Standon, Farmington Hills, MI (US); Todd Allen Campbell, LaSalle, MI (US); Ghanem Jandali, Farmington Hills, MI (US); Marcel Tschöpe, Weyhe (DE); Jens Ehlers, Weyhe (DE); Marco Heiling, Achim (DE); Torsten Baumach, Bremen (DE)

(21) Appl. No.: 19/149,140

(22) PCT Filed: Jan. 19, 2024
(86) PCT No.: PCT/US2024/012162

§ 371 Date: Jul. 18, 2025

Related U.S. Application Data
(60) Provisional application No. 63/439,954, filed on Jan. 19, 2023.

(51) Int. Cl. B60C 25/18

(52) U.S. Cl. CPC B60C 25/185

(57) ABSTRACT

A stem assembly system for a wheel may include a first robot configured to grip a wheel, at least one nest configured to maintain a stem for a wheel, a controller configured to instruct the robot to grip the wheel and move the wheel over the stem and apply the wheel to the stem to install the stem into a stem hole defined on the wheel, wherein the stem remains fixed on the nest during installation and the robot moves the wheel relative to the stem.

### CROSS-REFERENCE TO RELATED APPLICATIONS

This application claims the benefit of U.S. provisional application Ser. No. 63/439,954 filed Jan. 19, 2023, the disclosure of which is hereby incorporated in its entirety by reference herein.

### TECHNICAL FIELD

The present disclosure relates to automated system for assembling wheels, particularly for the automobile industry.

### BACKGROUND

Automated systems may be utilized to assemble wheels, which may be subsequently installed onto automobiles.

### SUMMARY

A stem assembly system for a wheel may include a first robot configured to grip a wheel, at least one nest configured to maintain a stem for a wheel, a controller configured to instruct the robot to grip the wheel and move the wheel over the stem and apply the wheel to the stem to install the stem into a stem hole defined on the wheel, wherein the stem remains fixed on the nest during installation and the robot moves the wheel relative to the stem.

A stem assembly system for a wheel may include a nest configured to maintain a stem for a wheel, and a robot configured to grip a wheel and move the wheel over the stem and apply the wheel to the stem to install the stem into a stem hole defined on the wheel, wherein the stem remains fixed on the nest during installation and the robot moves the wheel relative to the stem.

A nest assembly for a stem assembly system for a wheel assembly may include a first portion supporting a stem support, the stem support configured to maintain a stem for installation on a wheel, and a base portion attached to the first portion and a support rod extending through the first portion and the base portion to maintain the base portion and the first portion longitudinally, wherein the first portion and second portion are laterally movable with respect to one another in response to force received at the stem support from the wheel during installation, and wherein the first portion is laterally moveable with respect to the base portion.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective view of a stem assembly system;

FIG. 2 illustrates a side view of the stem assembly system of FIG. 1;

FIG. 3 illustrates a top view of the stem assembly system of FIG. 1;

FIG. 4 illustrates a perspective view of a nest of the stem assembly system;

FIG. 5 illustrates a perspective view of a portion of the stem assembly system of FIG. 1; and

FIG. 6 illustrates a cross-sectional view of a portion of the nest assembly of FIG. 4;

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

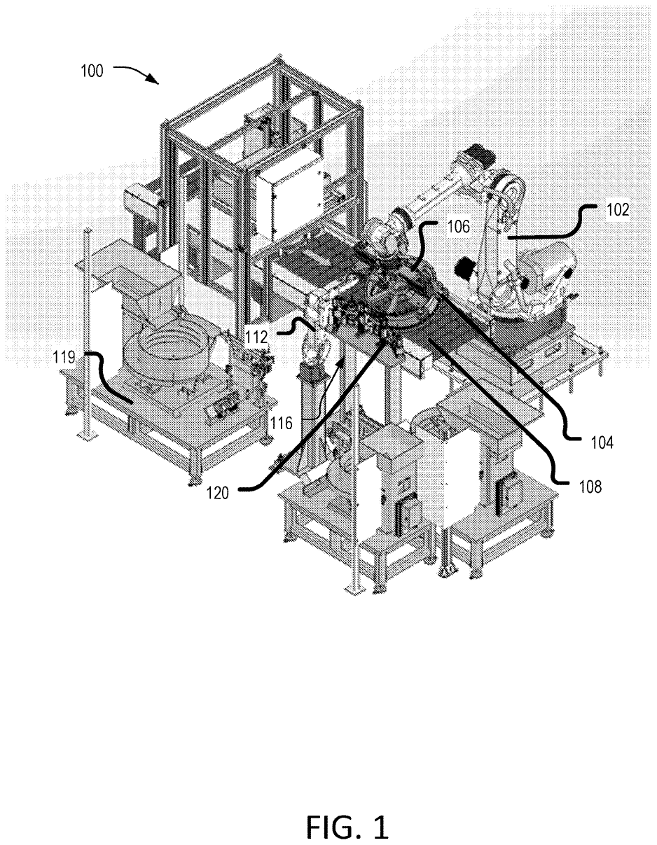

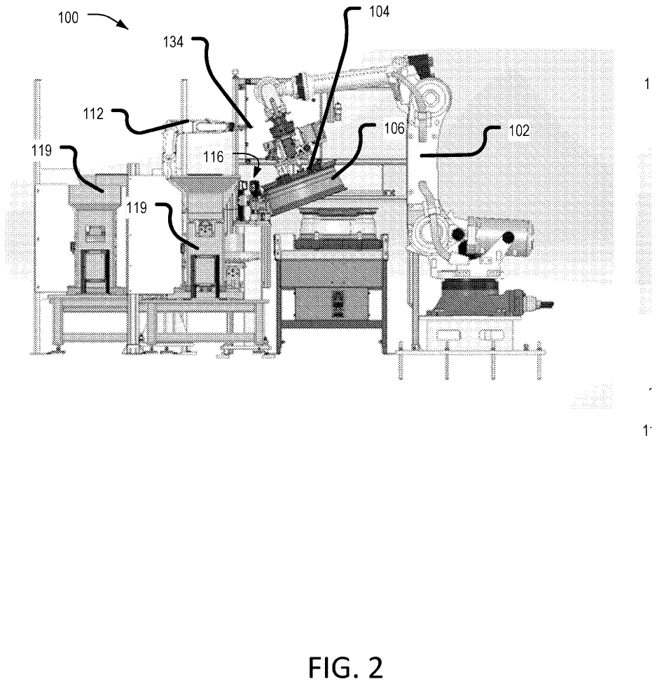

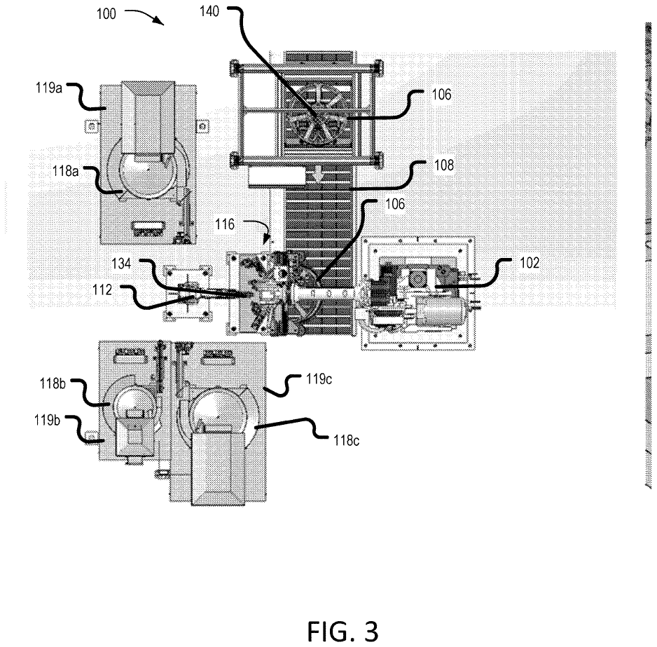

Referring to FIGS. 1-5, a stem assembly system 100 is described. The stem assembly system 100 may include at least one robot 102 including grippers 104 configured to grip a wheel 106. In the example illustrated, four grippers 104 may be arranged on a base and be configured to squeeze the wheel 106. The robot 102 may include at least one articulated joint and a wrist, and an arm. The arm may be positioned between the joint and the wrist and may allow for the grippers 104 to be capable of movement with at least three degrees of freedom along one of a selectable plurality of programmable predetermined paths. The joint may be mounted to a body portion that is connected to a base portion. In one exemplary arrangement, the body portion is rotatably-connected to the base portion such that the body portion may be pivoted relative to the base portion. Further, the body portion may be hinged to the base portion such that the body portion may be articulated vertically relative to the base portion.

The wheel 106 may be delivered to the robot 102 via a conveyor 108. Additionally or alternatively, the wheel 106 may be delivered via another robot, a base station, etc.

Cameras may be used to receive information about the location of the various components, including the stems and wheels. A first camera 140 may be arranged at or above the conveyor 108 to indicate the orientation of the wheel 106 at the first station. A second camera 142 may be arranged on the robot 102 and is configured to receive information about the location of a hole defined in the wheel 106. The hole is configured to receive a stem 110. The second camera 142 may indicate the angle the hole is at. The second camera 142 may be a fine tunning camera to align the hole with the stem 110 on a nest 116.

A second robot 112 may be arranged at an opposite side of the conveyor 108 than the first robot 102. Alternatively, the robots may be arranged on the same side of the conveyor 108. The second robot 112 may be configured to pick and place a stem 110 on a nest 116. The stems 110 may include tire pressure monitors (TPMs). The stems 110 may also include a base to prevent over insertion into the wheel 106 during assembly. The stems 110 may be housed in at least one bin 118 (individually labeled bins 118a, 118b, 118c and collectively referred to herein as bins 118). The bins 118 may each house a different size or type of stem. In one example, a motor may be arranged to vibrate each of the bins 118 to ensure that the stems are each lying flat on the bottom of the bin 118. This allows the second robot 112 to see and pick up distinct individual stems.

The bins 118 may include an associated hopper 119 (individually labeled hoppers 119a, 119b, 119c and collectively referred to here as hoppers 119). Operators may load the hoppers 119 and the stems 110 may be presented to the hoppers 119 one by one. The hoppers 119 may organize and orientate the stems 110 to ready the stems 110 for the second robot 112. The hopper 119 is configured to place the stems 110 in an upright configuration so that the second robot 112 may easily pick up the stems 110. Additionally or alternatively, the hoppers 119 may each be configured to release a predefined amount of stems 110 to the bin 118.

At least one other camera (not individually labeled) may be configured to receive information about the placement of the stems 110 within the bins 118. The camera may also be used to locate the nest 116 to place the stem 110 on the nest 116. The camera may be configured to acquire three dimensional images of the stems 110. This may allow the second robot 112 to locate the stems 110 within the bins, and allow for instructions for the second robot 112 to pick up a specific stem 110. Further, the camera may be arranged over the bins 118 and/or on the second robot 112. Thus, the camera may acquire the images of the bins, and a controller 130 may instruct the robot to pick up a specific stem 110 in a specific bin 118 based on this imaging.

The second robot 112 may, similar to the first robot 102, include at least one articulated joint and a wrist, and an arm. The arm may be positioned between the joint and the wrist and may allow for a clasp 134 to be capable of movement with at least three degrees of freedom along one of a selectable plurality of programmable predetermined paths. The joint may be mounted to a body portion that is connected to a base portion. In one exemplary arrangement, the body portion is rotatably-connected to the base portion such that the body portion may be pivoted relative to the base portion. Further, the body portion may be hinged to the base portion such that the body portion may be articulated vertically relative to the base portion.

During installation, the first robot 102 may grip the wheel 106 and move the wheel 106 to the nest 116, orient the hole of the wheel at a respective stem 110, and lower the wheel 106 onto the stem. Information received from the second camera allows for the robot 102 to accurately align the hole with the stem for proficient installation of the stem 110 therein.

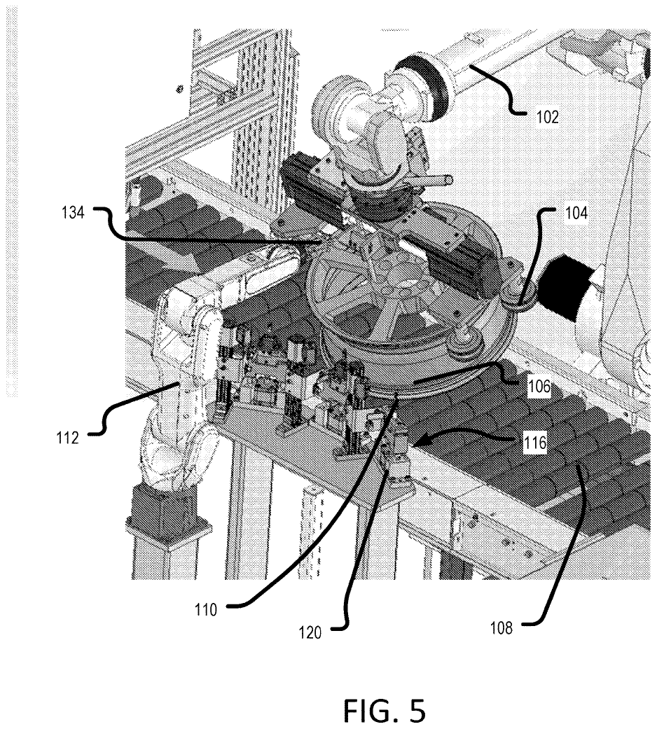

As best illustrated in FIG. 5, the second robot 112 may include the clasp 134, or a pair of fingers for gripping and holding the stems 110. The clasp 134 may pick up a stem 110 from a bin 118 and then grip the stem 110 and move the stem 110 to the nest 116 where the nest 116 may maintain the stem in a buffer position until the stem 110 is ready for installation on the wheel 106. The second robot 112 may include a force sensing device or force sensor (not individually labeled) to detect a force at which the stem 110 is placed on the nest 116.

The second robot 112 may continue to pick and place the stems 110 concurrent with other assembly steps. For example, while the first robot 102 is gripping and picking up the wheel 106 and moving the wheel 106, and placing the wheel on the stem 110 at the nest 116, the second robot 112 may concurrently be picking and placing other stems 110 on the nest. Such dual action steps may decrease assembly time and increase efficiency.

The nest 116 may be arranged adjacent the conveyor 108, but does not necessarily need to be. The nest 116, as best illustrated in FIG. 5, may include a plurality of hubs 120, each configured to receive a stem 110. In the examples shown, the nest 116 includes three hubs 120. Each hub 120 may be configured to receive a specific type of stem 110. Additionally or alternatively lasers may be used to determine the location of the stems and to verify other data, such as location of the stems in the bins, etc.

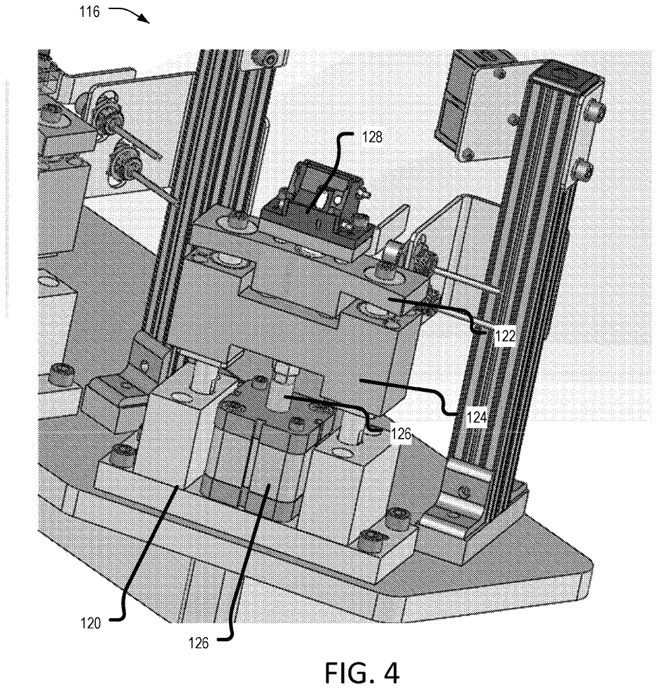

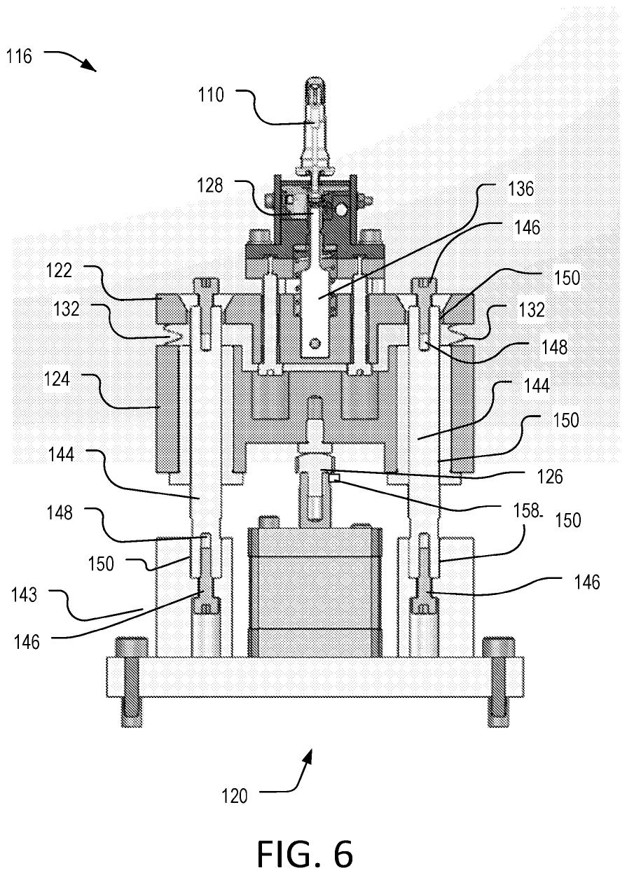

As best illustrated in FIGS. 4 and 6, each hub 120 may include a spring loaded first portion 122. This first portion 122 may be spring loaded via a biasing member or pair of springs 132 and configured to move laterally +/−2 mm, in one example. The springs 132 bias the first portion 122 away from the base portion 124. The nest 116 may include a base portion 124 configured to carry the first portion 122. The base portion 124 may be supported by a cylinder 126. A second portion 143 is arranged at the base of the hub 120. A channel 150 is defined through each of the first portion 122, base portion 124, and second portion 143, where the channel 150 of each of the respective portions aligns. In the example shown in FIG. 6, a pair of channels 150 are defined.

A support rod 144 may extend between the first portion 122, base portion 124 and second portion 143 within the channels 150. In the example shown in FIG. 6, the support rod 144 includes a pair of support rods. The support rod 144 may be fixed to each of the first portion 122 and the second portion 143 via bolts 146. The bolt 146 may secure the ends of the support rod 144 to the first portion 122 and the second portion 143. The support rod 144 may define an opening 148 at each end to receive the distal end of the respective bolt 146. The distal end of the bolt 146 may be configured to move laterally within this opening 148, while the proximal end of the bolt 146 is fixed to the respective portion 122, 143.

A stem receiver 128 may be arranged on the first portion 122 to receive and maintain the stem 110. The stem receiver 128 may maintain the stem 110 thereon until the respective stem 110 is ready for installation on the wheel 106. A spring 132 may be arranged between the first portion 122 and the stem receiver 128 to bias the receiver in a lateral position. The stem receiver 128 may include a pin 136 for receiving the stem 110 and the spring arranged below the receiver may allow the second robot 112 to push the stem 110 down on the pin until the stem 110 is seated on the pin.

The cylinder 126 may be an air cylinder and may be configured to monitor the force at which the stem 110 is placed on the stem receiver 128. The cylinder 126 may also measure the force at which the wheel 106 is placed on the stem 110 during installation of the stem 110. Additionally or alternatively, a distance sensor may be used to detect or determine a certain force. Each hub 120 may be configured to receive a specific size or type of stem 110. For example, one stem receiver 128 may be configured to receive and maintain a stem 110 having a TPM while another may not. The hubs 120 may alternatively be universal and capable of receiving various types of stems 110.

During assembly of the stem 110 on the wheel 106, the first robot 102 may move and angle the wheel 106 above the respective stem 110 on the hub 120. The first robot 102 may then move the wheel 106 so that a stem hole 115 (as best shown in FIG. 5) defined in the wheel 106 is aligned with the stem 110. The first robot 102 may then move the wheel 106 with a predefined force such that the stem 110 is received into the stem hole 115. During this process, the first portion 122 may move laterally in response to the force exerted on the stem 110. This may in turn compresses the springs 132 and cause the first portion 122 to move towards the base portion 124. The base portion 124 may in turn move towards the second portion 143, but such lateral movement is limited by the top of the second portion 143, as well as the cylinder 126 that supports the base portion 124.

The first portion 122, base portion 124, and second portion 143 are laterally movable with respect to one another, but constrained longitudinally by the support shaft 144. Thus, the arrangement of the hub 120 allows for lateral movement, and minimal longitudinal movement. This aids in allowing for some displacement during installation of the stem 110 to help work the stem 110 into the hole.

The system 100 may include a force sensing device 158 configured to detect the force at which the wheel 106 is being applied to the stem 110. In one example, the force detecting device 158 is arranged on the nest. Additionally or alternatively, the force sensing device 158 may be arranged on the first robot 102. Detection of force is important. As the robot 102 descends upon the stem 110 on the stem receiver 128, the stem 110 may be installed within the hole of the wheel 106. The force is controlled to fall within a threshold range. This includes a force not to exceed or fall outside of a predefined threshold so as to prevent damage to the wheel 106 and/or the stem 110 during installation and a lower threshold to ensure the stem is installed correctly.

Such force sensor may provide feedback so as to prevent damage to the nest 116, stem 110, or wheel 106 that could be caused by too much force and also ensure appropriate force for installation. In one example, the wheel 106 may land on the stem 110 with a force threshold range between 400-500N, but not to exceed 800-900N. Thus, the first robot 102 will insert the stem 110 with sufficient force, but also prevent a predetermined force from being exceeded. Such force feedback may be in addition to the force feedback acquired by the cylinder 126 on the hub 120.

The force sensing device 158 may include a force sensor arranged on the first robot 102. In another example, the force sensing device 158 may be a spring, force sensor, air spring, cylinder, distance sensor, etc. The cylinder 126 may act as the force sensing device 158. In one example, a force measuring device 158 may be arranged at both the hub 120 and the first robot 102.

As explained above, the system 100 may include at least two vision detectors. A first vision detector 140, or first camera 140, may be arranged above the conveyor 108 prior to the first robot 102 picking up the wheel 106. The first vision detector 140 may be configured to image the wheel 106 and identify, within a certain degree, the location of the stem hole 115. Such imaging may allow for instructions on where and how to grip the wheel 106. That is the controller 130 may analyze the image provided by the first vision detector 140 and pick up the wheel 106 via the grippers in a way that the grippers 104 will not obstruct the stem hole 115 or otherwise be in the way of installing the stem hole 115 over the stem 110. The second vision detector 142, or the second camera 142 may be arranged on the first robot 102 and may be configured to acquire an image of the wheel to provide precise instructions for installing the wheel 106 on the stem 110 at the nest 116. As also mentioned, the vision detectors may include lasers, or other devices capable of detecting objects. Further, the cameras may be used to audit the installation of the stem. For example, the second camera may be configured to provide information on the installation of the stem in the stem hole and the controller may then audit the installation of the stem based on this information.

The first robot 102 and the second robot 112 may be controlled by a controller 130 (illustrated in FIG. 1). The controller 130 may be stand-alone controller specific for stem assembly system 100, or may be a general controller for the general wheel assembly. The controller 130 may include one or more processors configured to perform instructions, commands and other routines in support of the processes described herein. Such instructions and other data may be maintained in a non-volatile manner using a variety of types of computer-readable storage medium. The computer-readable medium (also referred to as a processor-readable medium or storage) includes any non-transitory medium (e.g., a tangible medium) that participates in providing instructions or other data that may be read by the controller 130 or processor. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, Ladder Logic, and PL/SQL. The system may specifically implement and use a combination of TP programming (Teach Pendant programming) and Karel.

The controller 130 may be configured to control operation of the components of each of the first and second robots 102, 112, as well as other motors, cameras, etc. The controller 130 may be arranged at the system 100, or may be remote from the station and part of a global control system for the entire assembly system. The controller 130 may receive force data from the force detection device to make a determination whether the force has exceeded a predefined threshold. In response to the force data indicating a force that exceeds the threshold, the controller 130 may instruct the robot to cease installation to prevent any further damage to the wheel, stem, or nest.

Accordingly, an efficient stem assembly system is described herein. Specifically where a first robot moves a wheel to a stationary stem and installs the wheel onto the stem through the stem hole in the wheel. Unlike conventional systems where the wheel is stationary and the stem is installed on the wheel, the system described herein allows for more efficient cycle time, less damage to parts, lower floor space costs, among other advantages. A second robot may concurrently pick and place stems on a stationary nest and further increase efficiencies. Force sensors at the nest and robots may ensure compliance and less waste.

The embodiments of the present disclosure generally provide for a plurality of circuits, electrical devices, and at least one controller. All references to the circuits, the at least one controller, and other electrical devices and the functionality provided by each, are not intended to be limited to encompassing only what is illustrated and described herein. While particular labels may be assigned to the various circuit(s), controller(s) and other electrical devices disclosed, such labels are not intended to limit the scope of operation for the various circuit(s), controller(s) and other electrical devices. Such circuit(s), controller(s) and other electrical devices may be combined with each other and/or separated in any manner based on the particular type of electrical implementation that is desired.

It is recognized that any controller as disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any controller as disclosed utilizes any one or more microprocessors to execute a computer-program that is embodied in a non-transitory computer readable medium that is programmed to perform any number of the functions as disclosed. Further, any controller as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware based inputs and outputs for receiving and transmitting data, respectively from and to other hardware based devices as discussed herein.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A stem assembly system for a wheel, comprising:
a first robot configured to grip a wheel;
at least one nest configured to maintain a stem for a wheel; and
a controller configured to instruct the robot to grip the wheel and move the wheel over the stem and apply the wheel to the stem to install the stem into a stem hole defined on the wheel, wherein the stem remains fixed on the nest during installation and the robot moves the wheel relative to the stem.

2. The stem assembly system of claim 1, further comprising a second robot configured to, concurrent with the first robot gripping and moving the wheel, load the at least one nest with the stem.

3. The stem assembly system of claim 2, wherein the nest includes a plurality of nests, each configured to maintain a respective stem loaded by the second robot.

4. The stem assembly of claim 3, wherein the second robot is configured to load the plurality of nests, each with a distinct stem.

5. The stem assembly system of claim 1, further comprising at least one force sensing device configured to detect the force at which the wheel is applied to the stem.

6. The stem assembly system of claim 5, wherein the controller is further configured to receive force data from the force sensing device and determine whether the force falls outside of a predefined threshold range.

7. The stem assembly system of claim 6, wherein the controller is further configured to instruct the robot to cease installation in response to the force falling outside of the predefined threshold range.

8. The stem assembly system of claim 5, wherein the force sensing device is arranged at the nest.

9. The stem assembly system of claim 5, wherein the force sensing device is arranged at the first robot.

10. The stem assembly of claim 5, wherein the force sensing device is at least one of a cylinder, distance sensor and force sensor.

11. The stem assembly system of claim 1, further comprising at least one first camera arranged above a conveyor delivering the wheel to the first robot and providing imaging data to the controller, wherein the controller is further configured to instruct the first robot to grip the wheel according to the imaging data, where the imaging data determines an orientation of the stem hole.

12. The stem assembly system of claim 11, further comprising at least one second camera arranged on the robot and configured to provide information on the orientation of the stem hole.

13. The stem assembly system of claim 11, wherein the controller is further configured to receive information on a location of the stem hole and to instruct the robot to move the wheel over the stem and apply the wheel to the stem based on the location of the stem hole.

14. The stem assembly system of claim 13, wherein the location of the stem hole includes an orientation of the hole relative to the nest.

15. The stem assembly system of claim 14, wherein at least one second camera is configured to provide information on the installation of the stem in the stem hole and the controller is further configured to audit the installation of the stem based on this information.

16. A stem assembly system for a wheel, comprising:
a nest configured to maintain a stem for a wheel; and
a robot configured to grip a wheel and move the wheel over the stem and apply the wheel to the stem to install the stem into a stem hole defined on the wheel, wherein the stem remains fixed on the nest during installation and the robot moves the wheel relative to the stem.

17. The stem assembly of claim 16, wherein the nest includes a base portion and a stem support maintained on a first portion and laterally movable with respect to the base portion in response to force applied by the wheel to the stem during installation.

18. The stem assembly of claim 17, wherein at least one biasing device is arranged between the first portion and the base portion to bias the first portion away from the base portion.

19. A nest assembly for a stem assembly system for a wheel assembly, comprising:
a first portion supporting a stem support, the stem support configured to maintain a stem for installation on a wheel; and
a base portion attached to the first portion and a support rod extending through the first portion and the base portion to maintain the base portion and the first portion longitudinally, wherein the first portion and second portion are laterally movable with respect to one another in response to force received at the stem support from the wheel during installation, and wherein the first portion is laterally moveable with respect to the base portion.

20. The nest assembly of claim 19, wherein each of the base portion and the first portion define a channel for receiving the support rod therein to maintain the first portion and the base portion longitudinally fixed, the support rod extending between the channel of the first portion and the channel of the base portion, wherein each of the first portion and the base portion are laterally movable along the support rod, wherein at least one biasing device is arranged between the first portion and the base portion to bias the first portion away from the base portion.
